(19) United States
(12) Patent Application Publication
(10) Pub. No.: US 2019/0182202 A1
(43) Pub. Date: Jun. 13, 2019

(54) SYSTEM AND METHOD FOR ROUTE OPTIMIZATION IN A MULTICHASISS LINK AGGREGATION CONFIGURATION

(71) Applicant: Nokia Solutions and Networks Oy, Espoo (FI)

(72) Inventors: Diego Garcia Del Rio, San Francisco, CA (US); Krishna Ram Kuttuva Jeyaram, Santa Clara, CA (US); Karthik Shankar, Sunnyvale, CA (US); Suresh Boddapati, Pleasanton, CA (US)

(21) Appl. No.: 15/839,841

(22) Filed: Dec. 12, 2017

(51) Int. Cl. H04L 29/12; H04L 12/709; H04L 12/931

(52) U.S. Cl. CPC H04L 61/103; H04L 49/70; H04L 45/245

(57) ABSTRACT

A multi-chassis link aggregation (MC-LAG) system includes one or more dual homed nodes coupled to a pair of switches (MC pair) and one or more single homed nodes coupled to a single one of the MC pair of switches. The MC pair of switches advertises a virtual IP address for the dual homed nodes such that traffic may be received at either switch in the MC pair for the dual homed nodes. For a single homed node, a dedicated IP address is advertised associated with a switch in the MC pair locally connected to the single homed node. Traffic destined to the single homed node is thus transmitted to the switch in the MC pair locally connected to the single homed node.

### BACKGROUND

### Technical Field

The present disclosure relates generally to data networks and in particular to systems and methods for providing route optimization between nodes in a network with topological redundancy.

### Description of Related Art

Data networks may comprise, without limitation, local area networks, Enterprise Ethernet networks, data center networks, Metro Ethernet networks, wide area networks, or other types of networks that support multiple applications including, for example, voice-over-IP (VoIP), data and video applications. Such networks regularly include interconnected nodes, such as switches or routers, for switching/routing traffic through the data network. One of the key challenges faced by data networks is the need for network resiliency, i.e., the ability to maintain high availability despite eventual component failures, link failures or the like, which is critical to providing satisfactory network performance. Network resiliency may be achieved in part through topological redundancy, i.e., by providing redundant nodes (and redundant components within nodes) and multiple physical paths between nodes to prevent single points of failure. In addition, layer 2 (L2) or layer 3 (L3) protocols may also be used to determine redundant routing paths or upon occurrences of failures to converge upon alternate paths for switching/routing traffic flows through the network.

One network configuration with topological redundancy includes a dual-homed edge node connected to two or more switches via a single link-aggregation group (LAG). The LAG is terminated onto at least two network switches in what is commonly referred to as a multi-chassis LAG or “MC-LAG” configuration. Currently no “standard” exists for the MC-LAG technology. As such, devices implementing an MC-LAG configuration are from a same vendor or are otherwise interoperable. Other terms for MC-LAG known in the industry include, e.g., Virtual Port Concentrator (VPC) or MLAG.

A MC-LAG configuration of switches may host both dual homed servers and single homed servers. Currently routing for dual homed servers and single homed servers is handled similarly by the hosting switches. This similarity of routing is sub-optimal especially for the single homed servers.

Accordingly, there is a need for an improved system and method for routing in MC-LAG configurations and other redundant network topologies.

### SUMMARY

In an embodiment, a network node in a multi-chassis link aggregation (MC-LAG) system includes a virtual fabric link (VFL) configured for connection to a second network node, wherein the second network node includes a separate physical chassis. The network node and the second network node are configurable as a single logical endpoint with a common virtual internet protocol (IP) address. The network node further includes a first set of external ports coupled to at least one dual homed edge node and a second set of external ports coupled to a locally connected, single homed edge node. The network node further includes at least one processing circuit configured to associate the virtual IP address with the dual homed edge node and associate a dedicated IP address with the single homed edge node, wherein the dedicated IP address is specific to the network node.

In another embodiment, a method is operable in a first switch of an MC pair of switches in a multi-chassis link aggregation (MC-LAG) system. The method includes transmitting control messages over a multi-chassis (MC) interconnect link to the second switch in the MC-LAG system, wherein the MC pair of switches are configurable as a single logical endpoint having a common virtual internet protocol (IP) address. The method further includes processing a first packet from a single homed edge node coupled to the first switch of the MC pair, wherein the first packet includes a source MAC address associated with the single homed edge node. The method further includes generating a header for the first packet, wherein the layer 3 header includes the source MAC address associated with the single homed edge node and a dedicated IP address of the first switch.

In a third embodiment, a first switch is configurable in a multi-chassis (MC) pair of switches in a multi-chassis link aggregation (MC-LAG) system. The first switch includes a first set of ports configurable to transmit control messages over a multi-chassis (MC) interconnect link to a second switch in the MC-LAG system, wherein the MC pair of switches are configurable as a single logical endpoint having a common virtual internet protocol (IP) address. The first switch further includes at least a first processing circuit configured to determine a single edge node is locally connected to the first switch in the MC pair. The processing circuit is further configured to determine a dual homed edge node is connected to the first switch by a first set of links of an MC-LAG and to the second switch by a second set of links of the MC-LAG. The processing circuit is further configured to associate the virtual IP address with the dual homed edge node and associate a dedicated IP address with the single homed edge node, wherein the dedicated IP address is specific to the first switch.

In one or more of the above embodiments, a first set of external ports of the network node are connected to a first set of links of a multi-chassis link aggregation group (MC-LAG). The first set of links are coupled to the at least one dual homed edge node. A second set of links of the MC-LAG are connected to the at least one dual homed edge node and the second network node.

In one or more of the above embodiments, the dedicated IP address includes a system IP address of the network node.

In one or more of the above embodiments, the processing circuit is further configured to store a mapping of the dedicated IP address to a source MAC address of the single homed edge node in an address table. The processing circuit is further configured to store a mapping of the virtual IP address to a source MAC address of the dual homed edge node in the address table.

In one or more of the above embodiments, the processing circuit is further configured to detect a reconfiguration of the dual homed edge node to a second single homed edge node locally connected to the network node. The processing circuit is further configured to associate the second single homed edge node with the dedicated IP address of the network node.

In one or more of the above embodiments, the processing circuit is further configured to advertise a new preferred route for the second single homed edge node, wherein the new preferred route includes the dedicated IP address of the network node as the source IP address of the second single homed edge node.

In one or more of the above embodiments, the processing circuit is further configured to receive a layer 2 packet from the single homed node, wherein the layer 2 packet includes a source MAC address associated with the single homed node. The processing circuit is further configured to generate a layer 3 header for the layer 2 packet, wherein the layer 3 header includes the dedicated IP address of the network node as a source IP address.

In one or more of the above embodiments, the processing circuit is further configured to receive a layer 2 packet from the dual homed node, wherein the layer 2 packet includes a source MAC address associated with the dual homed node. The processing circuit is further configured to generate a layer 3 header for the layer 2 packet, wherein the layer 3 header includes the virtual IP address as a source IP address.

### BRIEF DESCRIPTION OF THE SEVERAL VIEWS OF THE DRAWINGS

Some embodiments of apparatus and/or methods in accordance with embodiments of the disclosure are now described, by way of example only, and with reference to the accompanying drawings, in which:

FIG. 1 illustrates an embodiment of a network including an MC-LAG system.

FIG. 2 illustrates a schematic block diagram of an embodiment of an MC-LAG system that configures a dedicated IP address for single homed nodes in an MC-LAG system.

FIG. 3 illustrates a schematic block diagram of another embodiment of an MC-LAG system that configures a dedicated IP address for single homed nodes in an MC-LAG system.

FIG. 4 illustrates a schematic block diagram of an embodiment of an MC-LAG system that configures a dedicated IP address in response to an MC-LAG failure in an MC-LAG system.

FIG. 5 illustrates a schematic block diagram of an embodiment of an MC-LAG system that configures a dedicated IP address in response to multiple MC-LAG failures in an MC-LAG system.

FIG. 6 illustrates a schematic block diagram of another embodiment of an MC-LAG system that configures a dedicated IP address in response to multiple MC-LAG failures in an MC-LAG system.

FIG. 7 illustrates a schematic block diagram of an embodiment of an MC-LAG system that configures a dedicated IP address in response to a standby status of one or more links of an MC-LAG in an MC-LAG system.

FIG. 8 illustrates a schematic block diagram of an embodiment of an MC-LAG system that configures a virtual IP address in response to an active status of the links of an MC-LAG in an MC-LAG system.

FIG. 9 illustrates a logical flow diagram of an embodiment of a method for advertising a new preferred route in an MC-LAG system.

FIG. 10 illustrates a schematic block diagram of an embodiment a switch in more detail.

FIG. 11 illustrates a logical flow diagram of an embodiment of a method of operation of a switch in a MC-LAG system.

### DETAILED DESCRIPTION

The description and drawings merely illustrate the principles of various embodiments. It will thus be appreciated that those skilled in the art will be able to devise various arrangements that, although not explicitly described or shown herein, embody the principles herein and in the claims and fall within the spirit and scope of the disclosure. Furthermore, all examples recited herein are principally intended expressly to be only for pedagogical purposes to aid the reader in understanding the principles of the embodiments and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass equivalents thereof.

The following standards are referred to in this application and are incorporated by reference herein: 1) the Link Aggregation Control Protocol (LACP) which was formerly clause 43 of the IEEE 802.3 standard added in March 2000 by the IEEE 802.3ad task force and is currently as incorporated in IEEE 802.1AX-2008 on Nov. 3, 2008; and 2) IEEE Std. 802.1Q, Virtual Bridged Local Area Networks, 2003 edition.

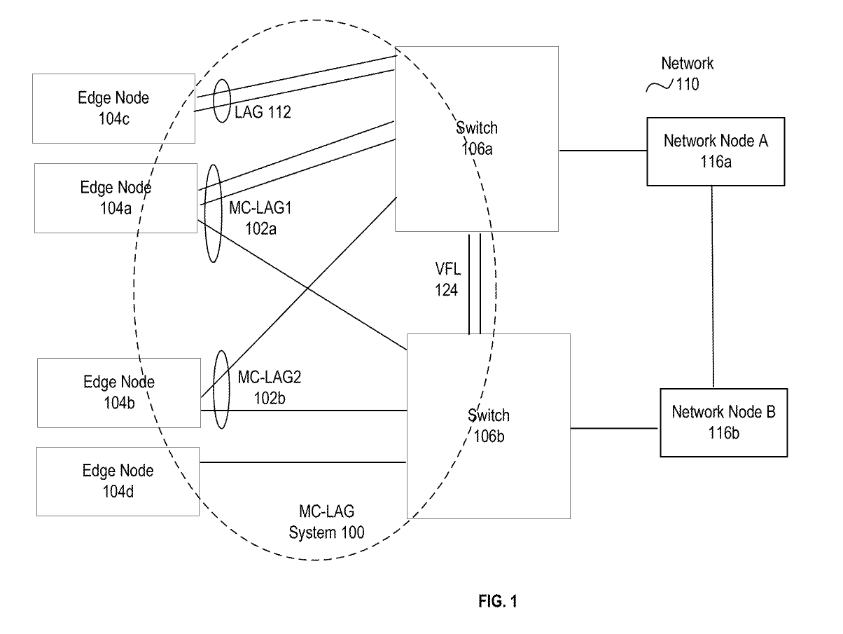

FIG. 1 illustrates an embodiment of an MC-LAG system 100 in a network 110. The MC-LAG system 100 includes a plurality of edge nodes 104 and a multi-chassis pair (MC pair) of switches 106a, 106b. In the example in this figure, one of the edge nodes 104a is connected to the pair of switches 106a, 106b by a first MC-LAG1 102a while another one of the edge nodes 104b is connected to the pair of switches 106a,106b by a second MC-LAG2 102b.

Each MC-LAG 102a, 102b includes a plurality of physical links divided into at least two sets, wherein each of the two sets includes at least one physical link. As seen in FIG. 1, a first set of the first MC-LAG1 102a includes physical links terminated at a set of ports of switch 106a, e.g. preferably coupled to different network interface cards (NICs) of the first switch 106a. A second set of MC-LAG1 102a includes physical links terminated at a set of ports of second switch 106b again preferably over different NICs of the second switch 106b. The two sets of physical links in the first MC-LAG1 102a form a single logical dual homed connection between the edge node 104a and the pair of switches 106a, 106b. The edge node 104a is thus a “dual homed” edge node 104a to the MC pair of switches 106a,106b.

Similarly, a first set of the second MC-LAG2 102b includes physical links terminated at a set of ports of the first switch 106a while a second set of the second MC-LAG2 102a includes physical links terminated at a set of ports of the second switch 106b. The two sets of physical links in the second MC-LAG2 102b form a single logical, dual homed path between the edge node 104b and the pair of switches 106a, 106b. The edge node 104b is thus a “dual homed” edge node 104b to the MC pair of switches 106a,106b.

An edge node 104 may use load balancing techniques to distribute traffic across all available links of a connected MC-LAG 102. For example, one of the physical links or set of physical links of an MC-LAG 102 is selected based on a load-balancing algorithm (usually involving a hash function operating on the source and destination Internet Protocol (IP) or Media Access Control (MAC) address information). Load balancing across the physical links of an MC-LAG 102 results in a more effective use of the bandwidth.

In an embodiment, the switches 106a and 106b are separate physical switches wherein each are active or operable as a stand-alone switch and each are encased by its own separate physical chassis with different system internet protocol (IP) addresses. The switches 106a and 106b may be in the same geographical area, such as in a central office or data center, or may be separate geographical locations, such as in different buildings or cities, to provide geo diversity. Each of the switches 106a, 106b may comprise a stack of switches operating as a single switch or other types of switch architectures. Though called switches herein, the switches 106 may be any type of network node, such as routers, bridges, etc. and may include routing or other functions.

The switches 106a, 106b are operably coupled by a dedicated link aggregation group (LAG) called an MC interconnect link or virtual fabric link (VFL) 124. The VFL 124 provides an interconnection between the switches 106 for exchange of traffic and control data in the MC-LAG system 100. For example, the control data may include MAC addressing tables, multicast flows, address resolution protocol (ARP) tables, Layer 2 control protocols (e.g. spanning tree, Ethernet ring protection, logical link detection protocol), routing protocols (e.g. RIP, OSPF, BGP) and state information of the switches 106 and external links. The VFL 124 may connect the two switches through an aggregate of ports on each switch that span multiple network interface cards for resiliency. The aggregate of ports is preferably connected by a LAG to form the VFL 124. The VFL 124 is configured for traffic flow and control data transfer between the pair of hosting switches 106a, 106b.

The edge nodes 104 may include a server, bridge, switch, router, etc., that is operating in a LAN, home network, enterprise network, data center, etc. The edge nodes 104 may also include a home network device, such as a digital subscriber line access multiplexer (DSLAM), cable modem termination system (CMTS), optical line terminal (OLT), etc. or other types of devices.

In an embodiment, the switches 106 are connected to a peer network, metro network or core network 110 that includes one or more network nodes 116a, 116b, such as Ethernet switches and/or IP routers. The network 110 may be a data center network, wherein the network nodes 116 are peers to the switches 106. In another embodiment, the switches 106 are aggregate switches and the network nodes 116 are part of a metro network or core network 110. The MC-LAG system 100 provides a dual-homed, multi-path connection between the edge nodes 104 and the network nodes 116.

In an embodiment, one or more edge nodes 104 may be connected to only one of the pair of switches 106 in a single homed configuration. For example, an edge node 104c is connected over a link aggregation group (LAG) 112 to only one of the pair of switches 106a. Another edge node 104d may be connected to another one of the pair of switches 106b and not the first switch 106a. The MC-LAG system 100 may thus host dual homed nodes 104a, 104b and single homed nodes 104c, 104d.

In one embodiment, the pair of switches 106a, 106b forms a single logical node or virtual endpoint. For example, the pair of switches 106a, 106b (also known as MC Pairs) is assigned a common virtual IP address for advertising to other network nodes 116. The network nodes 116 then learn the virtual IP address as the destination IP address for any of the edge nodes 104a-d connected to the pair of switches 106a, 106b. The network nodes 116 route packets destined to any of edge nodes 104a-d to the switches 106a, 106b using the virtual IP address, regardless of whether the edge nodes 104 are single homed or dual homed. The packets forwarded to the virtual IP address may arrive at either of the switches 106a, 106b.

For example, the network nodes 116 may forward a packet destined to an edge node 104 using the virtual IP address assigned to the MC pair of switches 106a, 106b. The packet may arrive at either of the MC pair of switches 106a, 106b. For a dual homed edge node 104a, 104b, either of the MC pair of switches 106a, 106b may forward the packet to the dual homed edge node 104a, 104b, because each of the MC pair of switches 106a, 106b is locally connected to the dual homed edge node 104a, 104b.

However, in the case of a single homed edge node 104c, 104d, the receiving switch 106 in the MC pair may not be locally connected to the edge node 104c, 104d. The receiving switch 106 must then transmit the packet to the other switch in the MC pair over the VFL 124 to reach the single homed edge node 104c, 104d. For example, a packet destined to the single homed edge node 104c connected to the first switch 106a of the MC pair may arrive at the second switch 106b of the MC pair. The second switch 106b of the MC pair must then forward the packet over the VFL 124 to the first switch 106a of the MC pair. The first switch 106a then forwards the packet received over the VFL 124 to the single homed edge node 104c. This routing for a single homed edge node is sub optimal and consumes the bandwidth of the VFL 124. The VFL 124 may have limited or low provisioned bandwidth that is not ideal for traffic flow, especially if one or more of the single homed edge nodes are in a heavy traffic state.

In an embodiment, the MC-LAG system 100 is modified such that traffic destined to a single homed node 104a, 104d is forwarded directly to the switch 106a, 106b of the MC pair that is locally connected to the single homed node 104c, 104d. The MC pair of switches 106a, 106b is each assigned a dedicated IP address, such as a system IP address. The system IP address of a switch 106 is specific to the switch 106 and identifies the switch 106 uniquely or separately from the other switch in the MC pair. This system IP address (or any other IP address that is specific or unique to the node) is used as the associated IP address for any locally connected, single homed node 104c, 104d. For example, in an address resolution protocol (ARP) requests or responses, a switch 106 advertises its dedicated IP address for locally connected, single homed nodes 104. The pair of switches 106a, 106b continues to advertise the virtual IP address for dual homed nodes 104a, 104b.

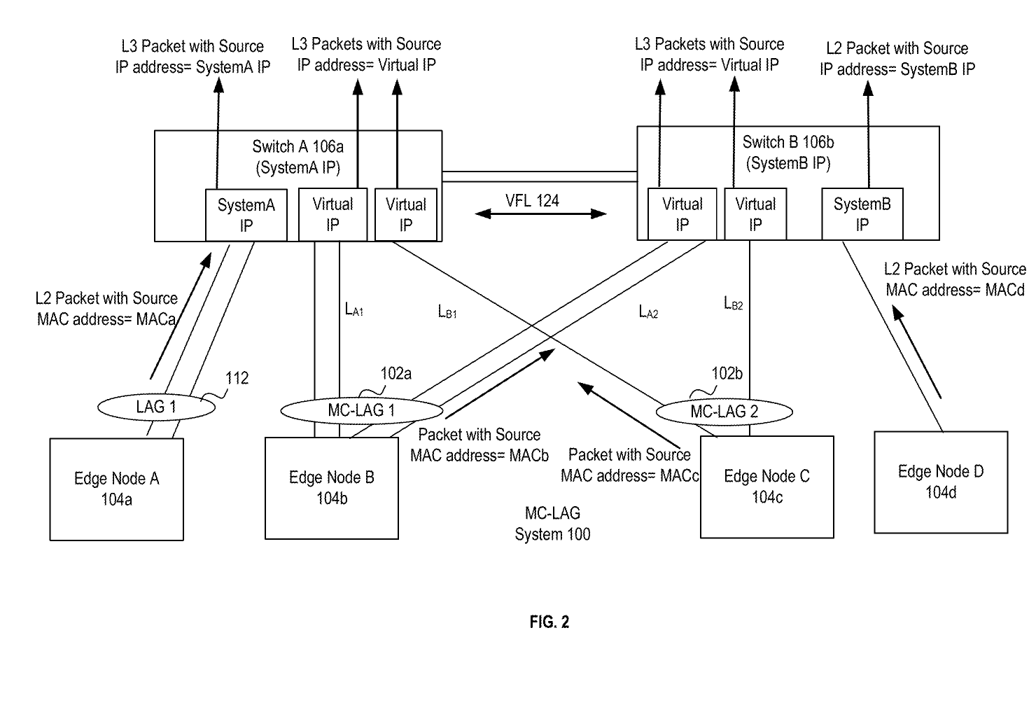

FIG. 2 illustrates a schematic block diagram of an embodiment of the use of a dedicated IP address for single homed nodes in an MC-LAG system 100. In this example, the first switch 106a is locally connected to the single homed edge node 104a over a first set of ports. The switch 106a receives a layer 2 packet with a source MAC address of MACa from the single homed edge node 104a. The switch 106a configures a L3 header for the L2 packet including its dedicated IP address.

For example, the switch 106a may encapsulate the L2 packet in an overlay packet including a L3 header or otherwise configure a L3 header for the L2 packet. A specific example of a Virtual eXtensible Local Area Network (VXLAN) wherein the switches 106 act as virtual tunnel end points (VTEPs) is described further herein. In the configured L3 header, the switch 106a includes its dedicated IP address “SystemA”. The switch 106a then forwards the L3 packet to one or more of the network nodes 116. The network nodes 116 then learn or update their routing tables to associate the MAC address MACa of the single homed edge node 104a with the dedicated IP address SystemA of the switch 106a. The first switch 106a thus advertises its dedicated, system IP address for the single homed edge node 104a.

In this example, the first switch 106a is also connected to the dual homed edge node 104b over a second set of ports and the second dual homed edge node 104c over a third set of ports. When the switch 106a receives a packet from a dual homed edge node 104b, 104c over another set of ports, the switch 106a includes a virtual IP address as the source IP address. The virtual IP address is assigned as a common logical IP address to the MC pair of switches 106a, 106b in the MC-LAG system 100. Thus, when edge node 104b transmits a L2 packet with a source MAC address MACb over MC-LAG1 102a to the switch 106a, the switch 106a includes the virtual IP address assigned to the MC pair. Similarly, when edge node 104c transmits a L2 packet with a source MAC address MACc over MC-LAG2 102b to the switch 106a, the switch 106a includes the virtual IP address assigned to the MC pair. The first switch 106a thus advertises the virtual IP address of the MC-LAG system for dual homed edge nodes 104b, 104c.

The second switch 106b in the MC pair is operably coupled to the dual homed edge nodes 104b, 104c over a first and second set of ports and operably coupled to the single homed edge node 104d over another set of ports. The second switch 106b similarly associates the virtual IP address assigned to the MC Pair with the dual homed edge nodes 104b, 104c. However, when the switch 106b receives a layer 2 packet with a source MAC address of MACd from the single homed edge node 104d, the switch 106b includes its dedicated IP address “SystemB”. The second switch 106b then forwards the packet to one or more of the network nodes 116. The network nodes 116 then learn or update their routing tables to associate the MAC address MACd of the edge node 104d with the System IP address “SystemB” of the second switch 106b.

The network nodes 116 may thus learn or include three IP addresses associated with the MC pair of switches 106a, 106b. An example of illustrative fields in an address or forwarding table is shown below.

TABLE 1

| MAC ADDRESS | IP Address |
|---|---|
| MACa | SystemA IP |
| MACb | Virtual IP |
| MACc | Virtual IP |
| MACd | SystemB IP |

As illustrated in Table 1, the network nodes 116 associate the virtual IP address of the MC Pair with the MAC addresses MACb, MACc of the dual homed edge nodes 104a, 104b. The network nodes 116 will thus look up the associated IP address of one of the dual homed edge nodes 104a, 104b and forward a packet using the virtual IP address assigned to the MC pair of switches 106a, 106b. The packet may then arrive at either of the MC pair of switches 106a, 106b. For the dual homed edge nodes 104a, 104b, either of the MC pair of switches 106a, 106b may then forward the packet to the destined dual homed edge node 104a, 104b, because each of the MC pair of switches 106a, 106b is locally connected to each of the dual homed edge nodes 104a, 104b.

For the single homed edge nodes, the network nodes 116 associate the dedicated IP address of the switch locally connected to the single homed edge node. For example, the MAC address MACa of the single homed edge node 104a is associated with the dedicated IP address SystemA of switch 106a. The MAC address MACb of the single homed edge node 104b is associated with the dedicated IP address SystemB of the switch 106b. The network nodes 116 thus forward a packet destined to a single homed edge node 104a, 104d using the dedicated IP address assigned to the hosting switch 106a, 106b in the MC pair that is locally connected to the single homed edge node 104a, 104b. The packet thus does not need to be forwarded over the VFL 124 between the switches 106a, 106b to arrive at the single homed edge node 104a, 104d.

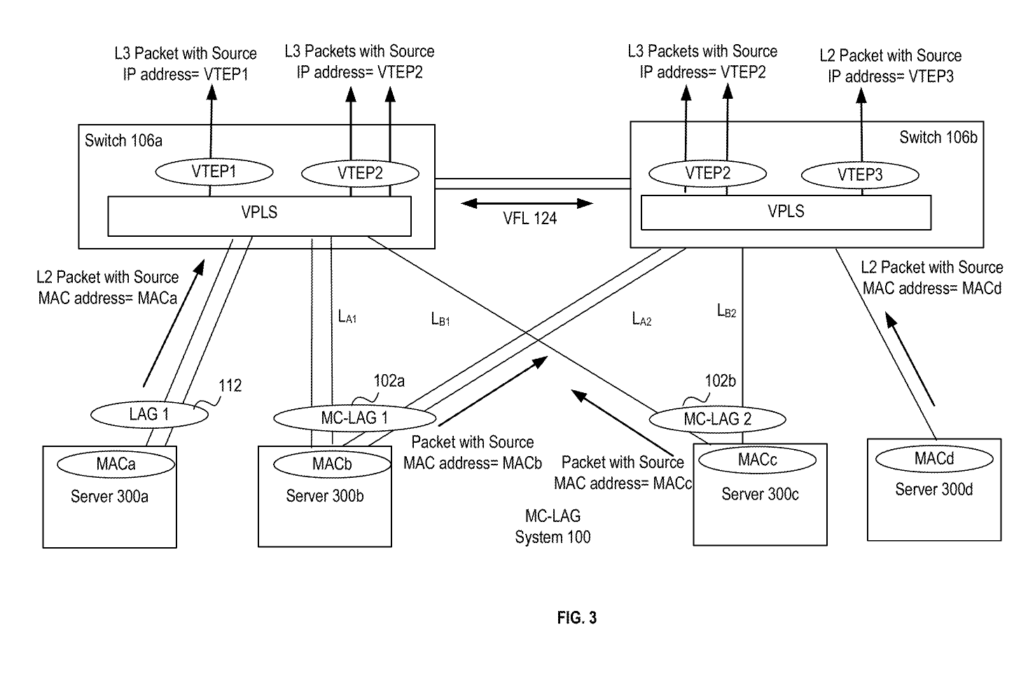

FIG. 3 illustrates a schematic block diagram of another embodiment of the use of a dedicated IP address for single homed nodes in an MC-LAG system 100. In this embodiment, a specific example of a Virtual eXtensible Local Area Network (VXLAN) is shown wherein the switches 106a, 106b act as virtual tunnel end points (VTEPs). VXLANs are described in more detail in IETF RFC 7348 Virtual eXtensible Local Area Network (VXLAN): A Framework for Overlaying Virtualized Layer 2 Networks over Layer 3 Networks, August 2014, which is hereby incorporated by reference herein.

In the VXLAN, the switches 106a, 106b encapsulate an L2 packet from servers 300a-d in an overlay packet including a L3 header. The system IP address (or any other IP address that is specific to the node) is used as the VTEP source IP address in the L3 header for advertising a single homed server's routes to peer nodes. The virtual IP of the MC pair is used as the VTEP source IP address in L3 headers for advertising dual homed server's routes to peer nodes. The peer nodes may thus learn at least three VTEP addresses associated with the MC pair of switches 106a, 106b: the virtual IP address of the MC pair, the dedicated IP address for the first switch 106a and the dedicated IP address for the second switch 106b. For implicit multicast routes, the switches 106a, 106b may still advertise the virtual IP address as the VTEP address.

For example, the first switch 106a is configured with at least two VTEPs: VTEP1 and VTEP2. VTEP1 is associated with a dedicated, system IP address of the switch 106a. The switch 106a maps the VTEP1 address to single homed locally connected servers, such as server 300a (or a virtual machine hosted by server 300a). For example, an ARP request is received from a peer node to discover the MAC address of the server 300a (or a virtual machine hosted on the server 300a). An entry in an address table of switch 106a includes a mapping of the virtual machine MACa address and the IP address of VTEP1. In this example, the virtual machine MAC1 running on server 300a is associated with the VTEP IP of VTEP1, e.g. the system IP of the switch 106a. The switch 106a replies to the ARP request by advertising the VTEP1 IP address for the server 300a. Thus, by default, the system IP or other dedicated IP address of the switch 106a is associated with the single homed, locally connected server 300a.

To advertise the presence of the single homed server 300a, VTEP1 encapsulates an Ethernet broadcast packet into a UDP header with a multicast address as the destination IP address and its dedicated IP address or VTEP1 address as the Source IP address for the server 300a. The Ethernet broadcast packet includes the source MAC address MACa for the server 300a. The network delivers the multicast packet to the other hosts in the multicast group. To advertise the presence of server 300b or 300c, VTEP2 of switch 106a encapsulates an Ethernet broadcast packet into a UDP header with a multicast address as the destination IP address and the virtual IP address (e.g., VTEP2 address) of the MC pair as the source IP address. The Ethernet broadcast packet includes the source MAC address MACb for the server 300b or MACc for the server 300c. The network delivers the multicast packet to the other hosts in the multicast group.

The second switch 106b is similarly configured with at least two VTEPs: VTEP2 and VTEP3. VTEP2 is associated with the virtual IP address of the MC pair and is mapped to the dual homed servers 300b, 300c. VTEP2 of the second switch 106b advertises the MAC address of the dual homed servers 300b or 300c (or virtual machines hosted by the servers 300b, 300c) to the virtual IP address (e.g., VTEP2 address) of the MC pair as the source IP address.

VTEP3 is associated with a dedicated, system IP address of the second switch 106b. The second switch 106b maps the VTEP3 address to single homed locally connected servers, such as server 300d (or a virtual machine hosted by server 300d). VTEP3 encapsulates an Ethernet packet into a UDP header with the dedicated IP address (e.g., VTEP3 address) as the source IP address for the server 300d when the Ethernet packet includes the source MAC address MACd for the server 300d.

In services, where only dual homed servers are present, only the Virtual IP may be used as the VTEP IP address for both implicit multicast route and any MAC/IP routes through the servers. In services, where there are only single homed servers, the system IP may be used as the VTEP IP address for any MAC/IP routes learnt through the servers. For flooded traffic (e.g., the implicit multicast route), the shared virtual IP may still be used in order to construct a single tunnel that serves both switches 106a, 106b with a single copy of packets.

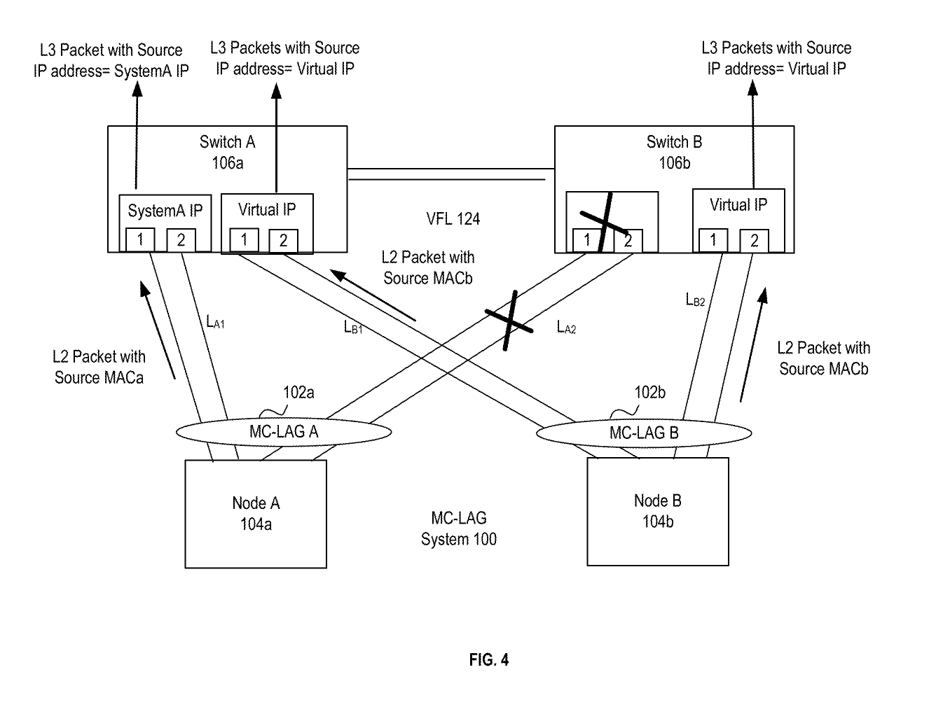

FIG. 4 illustrates a schematic block diagram of an embodiment of the use of a dedicated IP address in response to an MC-LAG failure in an MC-LAG system 100. In this embodiment, an MC-LAG failure has occurred wherein the connection between one of the dual homed nodes and switches 106 is inoperable (through either NIC failure, configuration, link failure or any other cause). In this example, the links of MC-LAGA 102a have failed or the network interface card has failed such that the connection between the Node A 104a and the second switch B 106b is inoperable. Due to the MC-LAG failure, the Node A 104a is now only connected to switch A 106a. Thus, Node A is now only locally connected to Switch A 106a. The Node B 104b is still dual homed to both switch A 106a and switch B 106b over the functional MC-LAGB 102b.

In this case, the MC-LAG system 100 is configured to switch the next-hop advertisement for only the particular mac-addresses/ip-addresses from the virtual IP to the dedicated IP of switch A 106a that still has valid connections. Thus, the source MAC address MACa of Node A 104a will be advertised with the dedicated system IP address of switch A rather than the virtual IP address of the MC pair. The source MACB address MACb of Node B 104b will continue to be advertised using the virtual IP address of the MC Pair. For flooded traffic (e.g., implicit multicast packets), the shared virtual IP may still be used in order to construct a single tunnel that serves both switches 106a, 106b with a single copy of the packets.

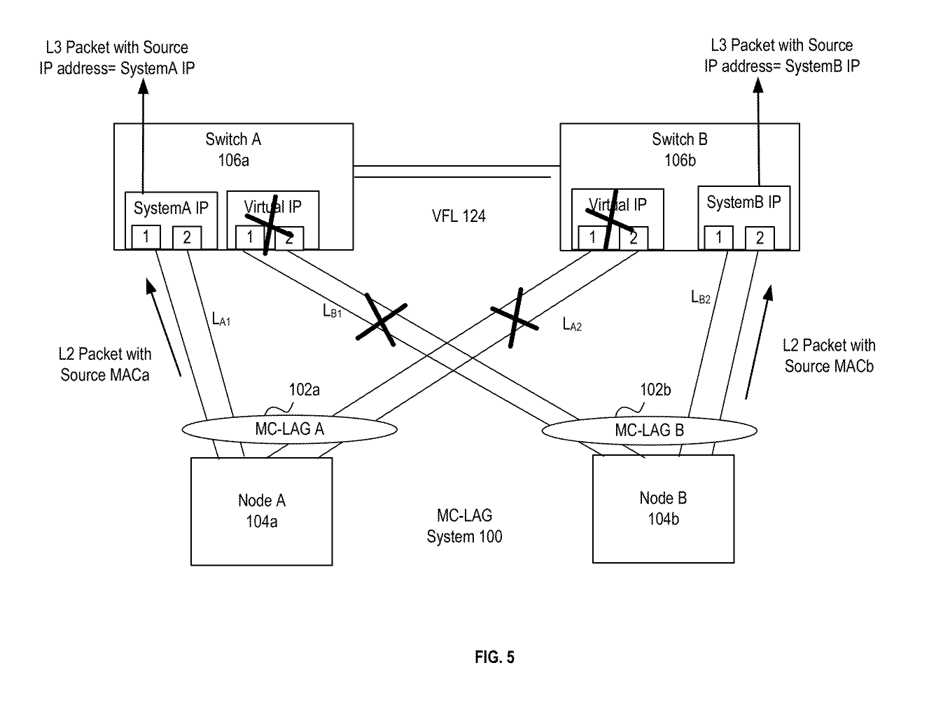

FIG. 5 illustrates a schematic block diagram of an embodiment of the use of dedicated IP addresses in response to multiple MC-LAG failures in an MC-LAG system 100. In this embodiment, a failure has occurred in both MC-LAGA 102a and MC-LAGB 102b. As such, the dual connections between Node A and Node B and the switches 106a and 106b are inoperable (through either NIC failure, configuration, link failure or any other cause). Node A is now locally connected to only switch A 106a while Node B is now locally connected to only Switch B 106b.

In response to the failure, the source MAC address MACa of Node A 104a is advertised with the dedicated system IP address of switch A rather than the virtual IP address of the MC pair. In addition, the source MACB address MACb of Node B 104b is advertised using the dedicated system IP address of switch B rather than the virtual IP address of the MC pair. Node A and Node B are now configured as locally connected to Switch A and Switch B respectively. For flooded traffic (e.g., implicit multicast packets), the shared virtual IP may still be used in order to construct a single tunnel that serves both switches 106a, 106b with a single copy of the packets.

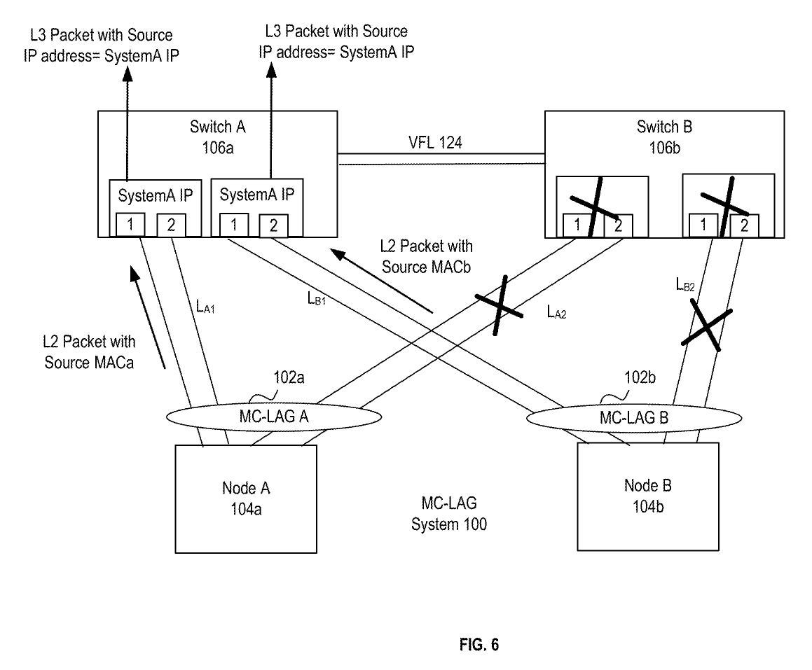

FIG. 6 illustrates a schematic block diagram of an embodiment of the use of a dedicated IP address in response to multiple MC-LAG failures in an MC-LAG system 100. In this embodiment, a failure has occurred in both MC-LAGA 102a and MC-LAGB 102b. As such, the dual connections between Node A and Node B and one of the MC Pair of switches is inoperable (through either NIC failure, configuration, link failure, switch failure or any other cause). Node A and Node B are now locally connected to only switch A 106a.

In response to the failure, the source MAC address MACa of Node A 104a is advertised with the dedicated system IP address of switch A rather than the virtual IP address of the MC pair. In addition, the source MAC address MACb of Node B 104b is advertised using the dedicated system IP address of switch A as well rather than the virtual IP address of the MC pair. Node A and Node B are now configured as locally connected to Switch A 106a. For flooded traffic (e.g., implicit multicast packets), the shared virtual IP may still be used in order to construct a single tunnel that serves both switches 106a, 106b with a single copy of the multicast packets. If Switch B 106b is in a standby mode or otherwise not functioning, Switch A 106a may advertise its dedicated, system IP address for implicit multicast packets.

The above configurations help to improve routing and resiliency to different failures. These configurations are beneficial in order to provide better traffic patterns for devices that have a failed link or equipment. In addition, these configurations may be used to adjust for active/stand-by connections as well as described hereinbelow.

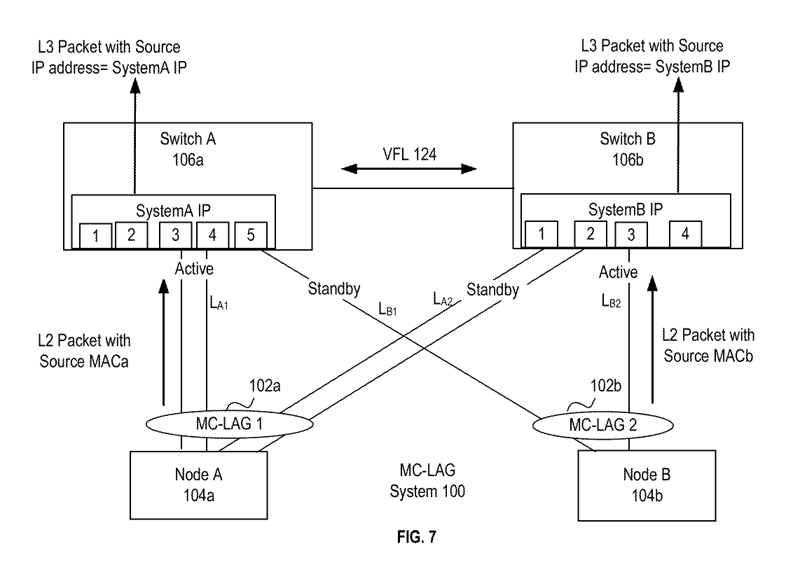

FIG. 7 illustrates a schematic block diagram of an embodiment of the use of dedicated IP addresses in response to a standby status of one or more links of an MC-LAG 102 in an MC-LAG system 100. In an example MC-LAG system configuration, one or more links of an MC-LAG 102 may be placed in standby mode. In an embodiment, one or more of the links of an MC-LAG in the multi-chassis system may operate in standby mode. For example, the links may be placed in standby for failover protection or during system upgrades or maintenance. In the example in FIG. 7, the subset of links L_{A2} of MC-LAG1 102a connecting Node A 104a and Switch B 106b are placed in standby mode. In addition, the subset of links L_{B1} of MC-LAG2 102b connecting Node B 104b and Switch A 106a are placed in standby mode. As such, Node A 104a is locally connected only to Switch A 106a and Node B 104b is locally connected only to Switch B 106b.

In response to the standby mode, the source MAC address MACa of Node A 104a is advertised with the dedicated system IP address of switch A rather than the virtual IP address of the MC pair. In addition, the source MAC address MACb of Node B 104b is advertised using the dedicated system IP address of switch B rather than the virtual IP address of the MC pair. Node A 104a and Node B 104b are now configured as locally connected to Switch A 106a and Switch B 106b respectively. For flooded traffic (e.g., implicit multicast packets), the shared virtual IP address may still be used in order to construct a single tunnel that serves both switches 106a, 106b with a single copy of the multicast packets.

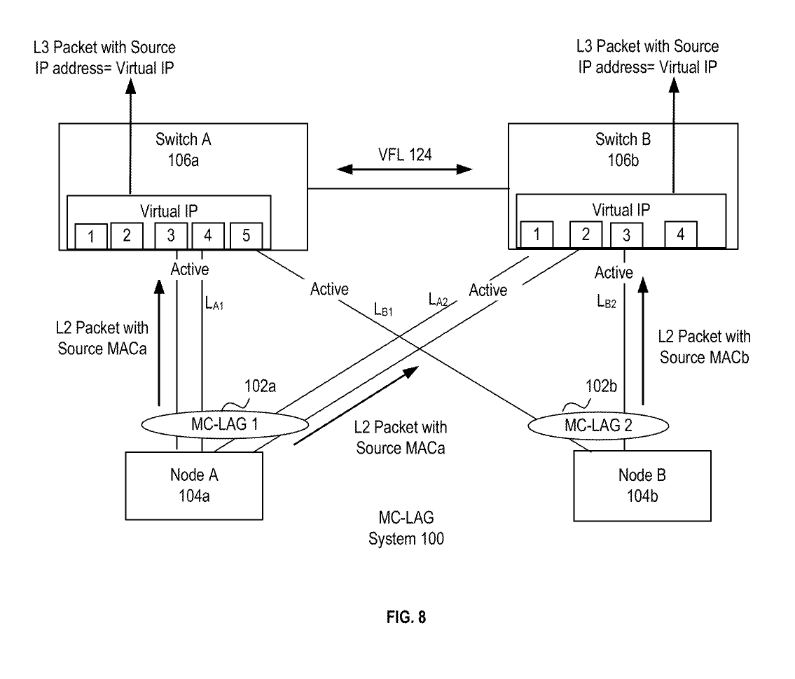

FIG. 8 illustrates a schematic block diagram of an embodiment of the use of virtual IP addresses in response to an active status of the links of an MC-LAG 102 in an MC-LAG system 100. In this example MC-LAG system configuration, the links of both MC-LAGs 102a, 102b are switched to an active mode. For example, the links may be placed in active mode to increase bandwidth or upon completion of system upgrades or maintenance. With the links in active mode, Node A and Node B are both dual homed to Switch A 106a and to Switch B 106b.

In response to the active mode, the source MAC address MACa of Node A 104a is advertised with the virtual IP address of the MC pair. In addition, the source MAC address MACb of Node B 104b is advertised using the virtual IP address of the MC pair. The configuration of the IP address may thus be changed in response to an active mode or standby mode of the MC-LAG links. This provides improved traffic patterns for devices that use active/stand-by connections.

As an additional enhancement, when a switch 106 in the MC-LAG system 100 reconfigures a VTEP or other type of interface from a Virtual IP address of an MC pair to a dedicated IP address, the switch 106 may advertise the reconfigured, dedicated IP address as a “preferred” route without removing the prior advertisement for the virtual IP address. This advertisement allows for a gradual transition to the reconfigured, dedicated IP address without a “route withdrawal”. A route withdrawal, depending on the timing, may lead to short but noticeable traffic outages as remote nodes first remove the route with the virtual IP as a destination and then install the dedicated IP address route. By instead providing an advertisement for a “preferred” route, the remote nodes may install the dedicated IP address route first without withdrawing the virtual IP address route. This method reduces the network churn of withdrawing a prefix.

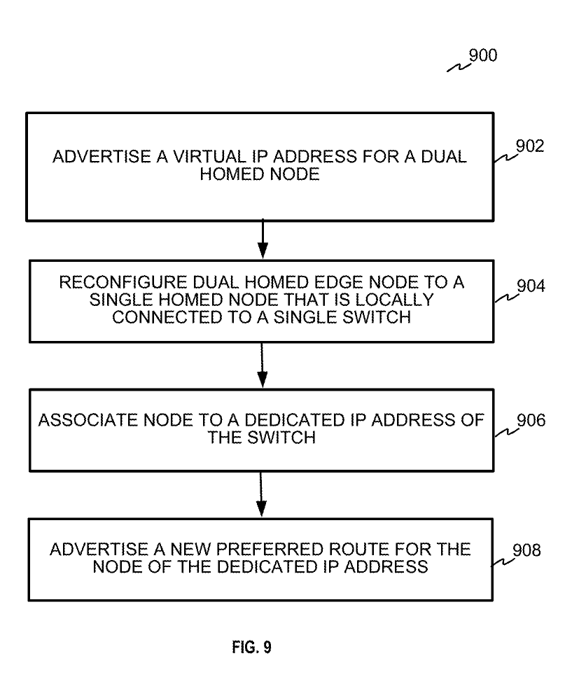

FIG. 9 illustrates a logical flow diagram of an embodiment of a method 900 for advertising a new preferred route in an MC-LAG system 100. A virtual IP address is assigned to a logical endpoint including the pair of switches 106a, 106b. The pair of switches 106a, 106b advertise the virtual IP address for a dual homed node at 902.

Due to a failure or system reconfiguration, the node may be reconfigured to a single homed node with a local connection to only one of the switches at 904. The node thus becomes a single homed, locally connected node (either through NIC failure, configuration, link failure, switch failure or any other cause). The switch 106 is operable to detect the reconfiguration of the node and modify its topology database and address table.

For example, in response to the reconfiguration, the switch 106 associates the source MAC address of the single homed node with the dedicated IP address of the switch rather than the virtual IP address of the MC pair at 906. The switch then advertises a new preferred route for the single homed node mapping the dedicated IP address with the MAC address of the single homed node at 908. For example, a Border Gateway Protocol (BGP) or other protocol may be used to set routing decisions based on paths, network policies, or rule-sets configured by a network administrator and is involved in making routing decisions. The ARP may be used to advertise the new mapping of the dedicated IP address with the MAC address of the single homed node.

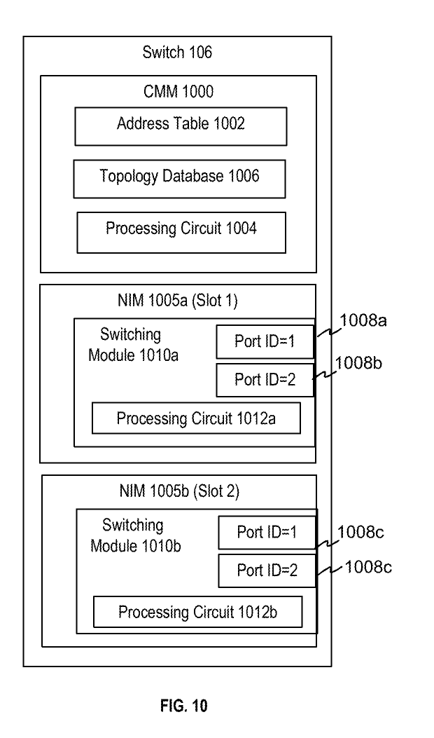

FIG. 10 illustrates a schematic block diagram of an embodiment of a switch 106 in more detail. The switch 106 may include a control management module (CMM) including an address table 1002, a topology database 1006 and processing circuit 1004. The address table 1002 stores a database of routes through the network and mapping from Layer 3 addresses (e.g., IP addresses) to Layer 2 addresses (e.g., Ethernet MAC addresses). For example, the switch 106 may store a mapping of the dedicated IP address to the source MAC addresses of the locally connected, single homed edge nodes 104 in the address table 1002. The switch 106 may also store a mapping of the virtual IP address to the source MAC addresses of the dual homed edge nodes 104 in the address table 1002.

The topology database includes identification information of other network nodes (e.g., local MAC address, chassis identifier), identification information for network interfaces that host the VFL 120 (or other active inter-switch links), identification information for locally connected, single homed edge nodes and dual homed edge nodes, etc. The processing circuit 1004 may include one or more non-transitory processor readable memories that store instructions which when executed by the processing circuit 1004, causes the processing circuit 1004 to perform one or more functions described herein.

The switch 106 further includes one or more network interface modules or cards (NIMs) 1005a, 1005b. The NIMs 1005a, 1005b each include a switching module 1010a, 1010b with one or more ports 1008a-d. The NIMs 1005a, 1005b may also include a subset of the address table 1002, e.g., with listings for local connections. The NIMs 1005a, 1005b may similarly each include a processing circuit 1012a, 1012b for processing incoming packets or for transmitting packets. The processing circuits 1012 may each include one or more non-transitory processor readable memories that store instructions which when executed by the processing circuits 1012, causes the processing circuits 1012 to perform one or more functions described herein.

A set of the ports 1008 of the switch 106 may be coupled to one or more locally connected, single homed edge nodes 104. Another set of ports 1008 of the switch 106 may be coupled to one or more dual homed edge nodes 104.

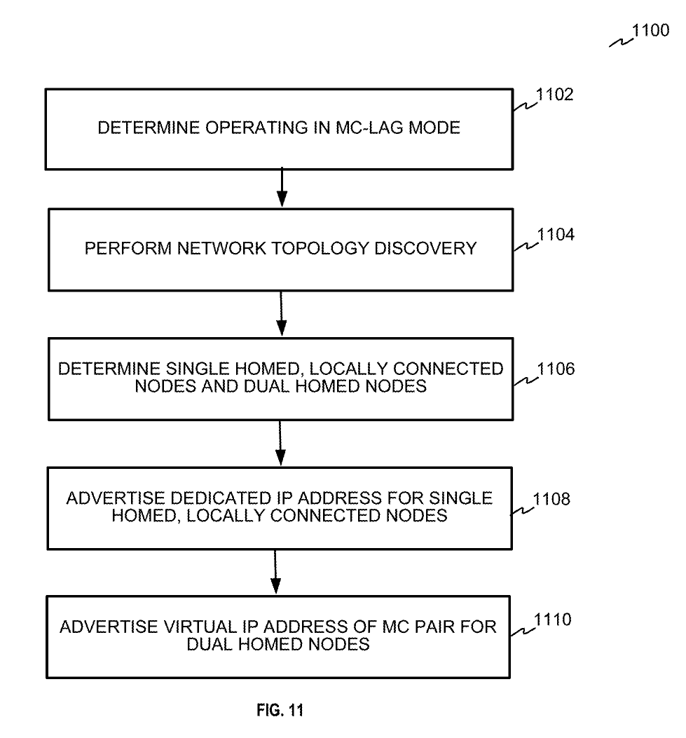

FIG. 11 illustrates a logical flow diagram of an embodiment of a method 1100 of operation of a switch 106 in a MC-LAG system 100. The switch 106 is operable to perform a network topology discovery process to determine locally connected single homed nodes and dual homed nodes. The topology discovery process may be performed by the switch 106 at start-up, reboot, on indication of a status change in the network or at predetermined time periods. For example, upon start-up, the switch 106 detects that it is operating in a MC-LAG mode or configuration at 1102. For example, one or more parameters of the switch 106 may be configured to indicate an MC-LAG mode of operation. The switch 106 detects that the parameters indicate the MC-LAG mode of operation (e.g., rather than stand-alone mode or multi-chassis mode). The switch 106 then performs one or more control protocols to discover other network nodes in the MC-LAG system 100 and to exchange topology and configuration information at 1104. In another embodiment, the switch 106 may be configured with the network topology information or receive the information from a network manager.

The switch 106 uses the information to build a topology database 1006 of the network 110. The topology database 1006 includes: identification information for the other switch in the MC pair, other network nodes (e.g., local MAC address, chassis identifier), identification information for network interfaces that host the VFL 120 (or other active inter-switch links), identification information for locally connected, single homed edge nodes and dual homed edge nodes, etc. The switch 106 learns the active connections and ports between the edge nodes 104 and one or more other switches 106 in the MC-LAG system 100 as well as other connected network nodes 116 in the network 110. The switch 106 is thus able to identify locally connected, single homed edge nodes and dual homed edge nodes in the MC-LAG system 100 at 1106. This topology is represented as data in the topology database 1006.

The switch 106 is configured to advertise a dedicated IP address (such as its system IP address) with layer 2 MAC addresses originating from locally connected, single homed edge nodes 104 at 1108. For example, in response to ARP requests, the switch 106 responds by mapping its dedicated IP address to the layer 2 MAC addresses of the locally connected, single homed edge nodes 104. When forwarding a layer 2 packet originated from locally connected, single homed edge nodes, the switch 106 inserts the dedicated IP address as the source IP address in a layer 3 header. The switch 106 may also store a mapping of the dedicated IP address to the source MAC addresses of the locally connected, single homed edge nodes 104 in the address table 1002.

The switch is further configured to advertise a virtual IP address (assigned to the MC-Pair in the MC-LAG system 100) with layer 2 MAC addresses originating from dual edge nodes 104 at 1110. For example, in response to ARP requests, the switch 106 responds by mapping the virtual IP address to the layer 2 MAC addresses of the dual homed edge nodes 104. When forwarding a layer 2 packet originated from dual homed edge nodes, the switch 106 inserts the virtual IP address as the source IP address in a layer 3 header. The switch 106 may also store a mapping of the virtual IP address to the source MAC addresses of the dual homed edge nodes 104 in the address table 1002.

In an embodiment, the MC-LAG system 100 is configured such that traffic destined to a single homed node 104a, 104d is forwarded directly to the switch 106a, 106b of the MC pair that is locally connected to a single homed node 104c, 104d. The MC pair of switches 106a, 106b are each assigned a dedicated IP address, such as a system IP address. This system IP address (or any other IP address that is specific to the node) is used as the associated IP address for any locally connected, single homed node 104c, 104d. For example, in an address resolution protocol (ARP) requests or responses, a switch 106 advertises its dedicated IP address for locally connected, single homed nodes 104c, 104d. The pair of switches 106a, 106b continue to advertise the virtual IP address for dual homed nodes 104a, 104b.

A processing circuit as described herein includes at least one processing device, such as a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. A memory device is a non-transitory memory device and may be an internal memory or an external memory, and the memory may be a single memory device or a plurality of memory devices. The memory device may be a read-only memory, random access memory, volatile memory, non-volatile memory, static memory, dynamic memory, flash memory, cache memory, and/or any non-transitory memory device that stores digital information. The term “module” is used in the description of one or more of the embodiments of elements herein. A module includes one or more processing devices and/or one or more non-transitory memory devices operable to perform one or more functions as may be described herein. A module may operate independently and/or in conjunction with other modules and may utilize the processing device and/or memory of other modules and/or operational instructions of other modules. As also used herein, a module may contain one or more sub-modules, each of which may be one or more modules.

As may be used herein, the term “operable to” or “configurable to” indicates that an element includes one or more of circuits, instructions, modules, data, input(s), output(s), etc., to perform one or more of the described or necessary corresponding functions and may further include inferred coupling to one or more other items to perform the described or necessary corresponding functions. As may also be used herein, the term(s) “coupled”, “coupled to”, “connected to” and/or “connecting” or “interconnecting” includes direct connection or link between nodes/devices and/or indirect connection between nodes/devices via an intervening item (e.g., an item includes, but is not limited to, a component, an element, a circuit, a module, a node, device, network element, etc.). As may further be used herein, inferred connections (i.e., where one element is connected to another element by inference) includes direct and indirect connection between two items in the same manner as “connected to”.

Note that the aspects of the present disclosure may be described herein as a process that is depicted as a schematic, a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

The various features of the disclosure described herein can be implemented in different systems and devices without departing from the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

In the foregoing specification, certain representative aspects have been described with reference to specific examples. Various modifications and changes may be made, however, without departing from the scope of the claims. The specification and figures are illustrative, rather than restrictive, and modifications are intended to be included within the scope of the claims. Accordingly, the scope of the claims should be determined by the claims and their legal equivalents rather than by merely the examples described. For example, the components and/or elements recited in any apparatus claims may be assembled or otherwise operationally configured in a variety of permutations and are accordingly not limited to the specific configuration recited in the claims.

Furthermore, certain benefits, other advantages and solutions to problems have been described above with regard to particular embodiments; however, any benefit, advantage, solution to a problem, or any element that may cause any particular benefit, advantage, or solution to occur or to become more pronounced are not to be construed as critical, required, or essential features or components of any or all the claims.

As used herein, the terms “comprise,” “comprises,” “comprising,” “having,” “including,” “includes” or any variation thereof, are intended to reference a nonexclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present embodiments, in addition to those not specifically recited, may be varied or otherwise particularly adapted to specific environments, manufacturing specifications, design parameters, or other operating requirements without departing from the general principles of the same.

Moreover, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is intended to be construed under the provisions of 35 U.S.C. § 112(f) as a “means-plus-function” type element, unless the element is expressly recited using the phrase “means for” or, in the case of a method claim, the element is recited using the phrase “step for.”

While particular combinations of various functions and features of embodiments are expressly described herein, other combinations of these features and functions are likewise possible. The embodiments described herein are not limited by the particular examples described and may include other combinations and implementations.

What is claimed is:

1. A network node in a multi-chassis link aggregation (MC-LAG) system, comprising:
a virtual fabric link (VFL) configured for connection to a second network node, wherein the second network node includes a separate physical chassis and wherein the network node and the second network node are configurable as a single logical endpoint with a common virtual internet protocol (IP) address;
a first set of external ports coupled to a dual homed edge node;
a second set of external ports coupled to a locally connected, single homed edge node;
at least one processing circuit configured to:
associate the virtual IP address with the dual homed edge node; and
associate a dedicated IP address with the single homed edge node, wherein the dedicated IP address is specific to the network node.

2. The network node of claim 1, wherein the first set of external ports are connected to a first set of links of a multi-chassis link aggregation group and wherein the first set of links are coupled to the at least one dual homed edge node.

3. The network node of claim 2, wherein a second set of links of the MC-LAG are connected to the at least one dual homed edge node and the second network node.

4. The network node of claim 1, wherein the dedicated IP address includes a system IP address of the network node.

5. The network node of claim 1, wherein the at least one processing circuit is further configured to:
store a mapping of the dedicated IP address to a source MAC address of the single homed edge node in an address table; and
store a mapping of the virtual IP address to a source MAC address of the dual homed edge node in the address table.

6. The network node of claim 1, wherein the at least one processing circuit is further configured to:
detect a reconfiguration of the dual homed edge node to a second single homed edge node locally connected to the network node; and
associate the second single homed edge node with the dedicated IP address of the network node.

7. The network node of claim 6, wherein the at least one processing circuit is further configured to:
advertise a new preferred route for the second single homed edge node, wherein the new preferred route includes the dedicated IP address of the network node as a source IP address of the second single homed edge node.

8. The network node of claim 1, wherein the at least one processing circuit is further configured to:
receive a layer 2 packet from the single homed edge node, wherein the layer 2 packet includes a source MAC address associated with the single homed node; and
generate a layer 3 header for the layer 2 packet, wherein the layer 3 header includes the dedicated IP address of the network node as a source IP address.

9. The network node of claim 8, wherein the at least one processing circuit is further configured to:
receive a layer 2 packet from the dual homed edge node, wherein the layer 2 packet includes a source MAC address associated with the dual homed edge node; and
generate a layer 3 header for the layer 2 packet, wherein the layer 3 header includes the virtual IP address as a source IP address.

10. A method operable in a first switch of an MC pair of switches in a multi-chassis link aggregation (MC-LAG) system, comprising:
transmitting control messages over a multi-chassis (MC) interconnect link to a second switch of the MC pair of switches in the MC-LAG system, wherein the MC pair of switches are configurable as a single logical endpoint having a common virtual internet protocol (IP) address;
processing a first packet from a single homed edge node coupled to the first switch of the MC pair, wherein the first packet includes a source MAC address associated with the single homed edge node; and
generating a header for the first packet, wherein the layer 3 header includes the source MAC address associated with the single homed edge node and a dedicated IP address of the first switch.

11. The method of claim 10, further comprising:
processing a second packet from a dual homed edge node, wherein the dual homed edge node is coupled to the first switch and the second switch of the MC pair, and wherein the second packet includes a source MAC address associated with the dual homed edge node; and
generating a header for the second packet, wherein the header includes the source MAC address associated with the dual homed edge node and the virtual IP address of the MC pair of switches.

12. The method of claim 11, further comprising:
storing a mapping of the dedicated IP address to a source MAC address of the single homed edge node in an address table; and
storing a mapping of the virtual IP address to a source MAC address of the dual homed edge node in the address table.

13. The method of claim 11, further comprising:
detecting a reconfiguration of the dual homed edge node to a second single homed edge node, wherein the second single homed edge node is locally connected to the first switch; and
associating the second single homed edge node with the dedicated IP address of the first switch.

14. The method of claim 13, further comprising:
advertising a new preferred route for the second single homed edge node, wherein the new preferred route includes the dedicated IP address of the first switch as the source IP address of the second single homed edge node.

15. The method of claim 14, further comprising:
determining a network topology of the MC-LAG system;
determining the single homed edge node is locally connected to the first switch of the MC pair; and
determining the dual homed edge node is connected to the first switch by a first set of links of an MC-LAG and to the second switch by a second set of links of the MC-LAG.

16. The method of claim 15, further comprising:
detecting a failure in communication over the second set of links of the MC-LAG to the dual homed edge node;
reconfiguring the dual homed edge node as a single homed edge node that is locally connected to the first switch of the MC pair; and
associating the second single homed edge node with the dedicated IP address of the first switch.

17. A first switch configurable in a multi-chassis (MC) pair of switches in a multi-chassis link aggregation (MC-LAG) system, comprising:
a first set of ports configurable to transmit control messages over a multi-chassis (MC) interconnect link to a second switch in the MC-LAG system, wherein the MC pair of switches are configurable as a single logical endpoint having a common virtual internet protocol (IP) address;
at least one processing circuit configured to:
determine a single homed edge node is locally connected to the first switch in the MC pair; and
determine a dual homed edge node is connected to the first switch by a first set of links of an MC-LAG and to the second switch by a second set of links of the MC-LAG;
associate the virtual IP address with the dual homed edge node; and
associate a dedicated IP address with the single homed edge node, wherein the dedicated IP address is specific to the first switch.

18. The first switch of claim 17, wherein the at least one processing circuit is further configured to:
store a mapping of the dedicated IP address to a source MAC address of the single homed edge node in an address table; and
store a mapping of the virtual IP address to a source MAC address of the dual homed edge node in the address table.

19. The first switch of claim 17, wherein the at least one processing circuit is further configured to:
receive a layer 2 packet from the single homed edge node, wherein the layer 2 packet includes a source MAC address associated with the single homed edge node; and
generate a layer 3 header for the layer 2 packet, wherein the layer 3 header includes the dedicated IP address as a source IP address.

20. The first switch of claim 19, wherein the at least one processing circuit is further configured to:
receive a layer 2 packet from the dual homed edge node, wherein the layer 2 packet includes a source MAC address associated with the dual homed edge node; and
generate a layer 3 header for the layer 2 packet, wherein the layer 3 header includes the virtual IP address as a source IP address.
